(19) United States
(12) Patent Application Publication
(10) Pub. No.: US 2003/0175673 A1
(43) Pub. Date: Sep. 18, 2003

(54) Sound generating device capable of reading codes

(75) Inventor: Charng-Long Lee, Hsinchu City (TW)

Correspondence Address: BACON & THOMAS, PLLC, 625 SLATERS LANE, FOURTH FLOOR, ALEXANDRIA, VA, 22314

(73) Assignee: Sunplus Technology Co., Ltd., Hsin-Chu (TW)

(21) Appl. No.: 10/382,488

(22) Filed: Mar. 7, 2003

(30) Foreign Application Priority Data
Mar. 13, 2002 (TW) 91202977

(51) Int. Cl. G09B 5/04

(52) U.S. Cl. 434/319; 434/307 R

(57) ABSTRACT

A sound generating device capable of reading codes is disclosed for reading machine readable code arranged on printing material to generate corresponding voice output. An image sensor captures an image of the machine readable code. An image processor preprocesses the image of the machine readable code for acquiring identifiable image signals. A decoder decodes the image signals, based on encoding rules of the machine readable code, into texts or symboles represented by the machine readable code. A voice generating table pre-stored with voice waveforms corresponding to various texts and symbols converts the decoded texts or symbols into voice waveforms. A digital to analog convertor converts the voice waveforms into corresponding analog speech or special sound effect to a speaker for broadcasting.

### BACKGROUND OF THE INVENTION

1. Field of the Invention

The present invention relates to a device for assisting reading, and more particularly to a sound generating device capable of reading codes.

2. Description of Related Art

With the advance of information society, people can get information through various media. However, reading from printing materials, such as books or cards, is still a major way for acquiring knowledges and propagating information since it is conveniently and easily. In order to further enhance the convenience of reading books, many books are appended with CDs or tapes for playing the sound of the information in the book. Alternatively, an integrated circuit chip recorded with the sound of the information of the book may be embedded directly in the book for allowing the reader to listen to the content of the book, instead of reading the book.

However, the use of additional tapes, CDs or integrated circuit chips to assist reading is too expensive and is not suitable for all kinds of books or cards. Furthermore, if the amount of the information in the book is large, it is not easy to record all content of the book in the tapes, CDs, or integrated circuit chips.

To avoid the aforementioned problems, a direct solution is to capture the image of the book or card by a camera, and then recognize the content of the image with the text recognization technology, so as to pronounce the content of the book or card. To read the information of the image, a high technical text recognization is required since a large amount of calculation is required. Therefore, a personal computer with an image capture card is necessary. Such a solution is inconvenient since the personal computer is too expensive, bad in portability, and poor in flexibility due to strict restriction in editing text. Moreover, the recognization rate of text is not perfect, and the symbols of music scores or other special sound effects can not be read. Thus, this is not a feasible way for reading a book.

### SUMMARY OF THE INVENTION

Accordingly, the primary object of the present invention is to provide a sound generating device capable of reading codes, which is cheap, highly portable and flexible.

In accordance with one aspect of the present invention, the sound generating device capable of reading codes in accordance with the present invetion is provided for reading machine readable code arranged on printing material to generate corresponding voice output. The sound generating device comprises: an image sensor for capturing an image of the machine readable code; an image processor for preprocessing the image of the machine readable code for acquiring identifiable image signals; a decoder for decoding the image signals, based on encoding rules of the machine readable code, into texts or symboles represented by the machine readable code; a voice generating table pre-stored with voice waveforms corresponding to various texts and symbols for converting the decoded texts or symbols into voice waveforms; and a digital to analog convertor for converting the voice waveforms into corresponding analog speech or special sound effect to a speaker for broadcasting.

In accordance with another aspect of the present invention, the sound generating device capable of reading codes is provided for reading machine readable code arranged on printing material. The machine readable code represents the digital waveforms of texts or symbols on the printing material. The device comprises: an image sensor for capturing an image of the machine readable code; an image processor for preprocessing the image of the machine readable code for acquiring identifiable image signals; a decoder for decoding image signals, based on encoding rules of the machine readable code, into digitalized waveforms of texts or symboles represented by the machine readable code; and a digital to analog convertor for converting the digitalized waveforms into corresponding analog speech or speech sound effect to a speaker for broadcasting.

The various objects and advantages of the present invention will be more readily understood from the following detailed description when read in conjunction with the appended drawing.

### BRIEF DESCRIPTION OF THE DRAWINGS

FIG. 1 is a schematic view showing the application of the sound generating device capable of reading codes according to the present invention.

FIG. 2 shows the functional block diagram of the sound generating device capable of reading codes according to the present invention.

### DETAILED DESCRIPTION OF THE PREFERRED EMBODIMENT

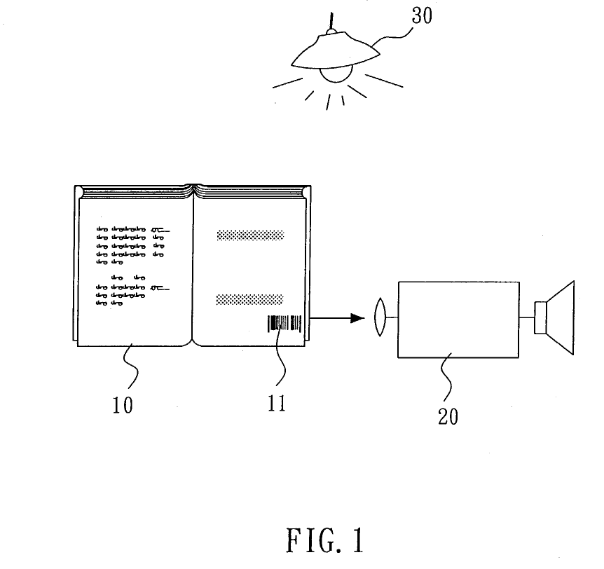

Referring to FIG. 1, a preferred embodiment of the sound generating device capable of reading code according to the present invention is illustrated. The sound generating device capable of reading code 20 serves for reading the machine readable code 11 printed on a book 10 or a card for generating corresponding voice output. Preferably, the machine readable code 11 is a two-dimensional barcode or other machine readable symbol, which is printed on the comer of a page of the book so as not to influence the edition of the book. Alternatively, the code can be printed in a hidden manner on the page of the book or card by using non-visible lihgt material, fluerescent light, or watermark. The machine readable code 11 represents the text or symbols in a part or whole of the content of a page of the book to be read, or the digital waveform of the text or symbols.

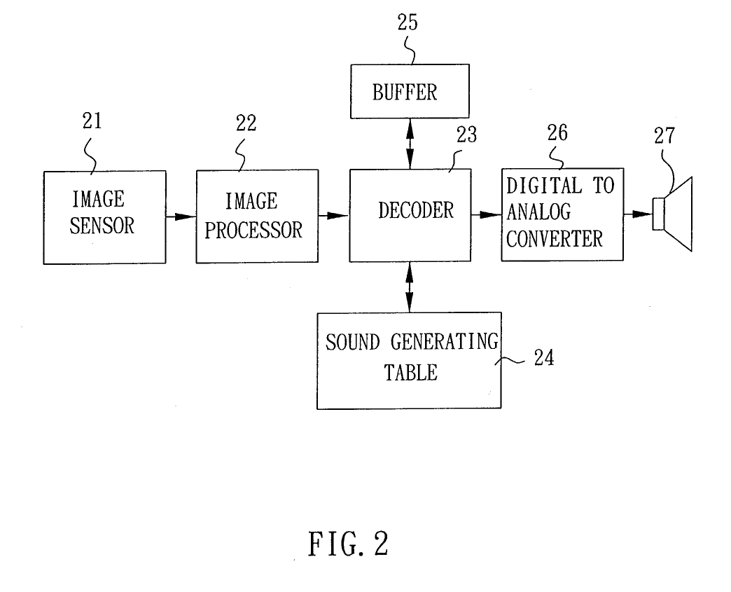

Referring to FIG. 2, the sound generating device capable of reading code 20 includes an image sensor 21, an image processor 22, a decoder 23, a voice generating table 24, a buffer 25, a digital to analog convertor 26 and a speaker 27. The voice generating table 24 is stored with stored wavefroms corresponding to different texts or symbols.

The image sensor 21 is, for example, a CCD or CMOS semiconductor device for capturing the image of the machine readable code 11. The image processor 22 serves to perform a preprocess for the image, namely, exposure, noise reduction, color correction, image enhancing, and the digitization of an image or other related preocess so as to acqurie an identifiable image for further decoding.

The preprocessed image is first stored in the buffer 25 for being decoded by the decoder 23 according to the encoding rules of the two-demensional barcode, so as to extract the texts or symbols in the image. The decoded texts or symbols are stored in the buffer 25. Then, based on the decoded texts or symbols, the corresponding voice waveforms are taken out from the voice generating table 24 for being converted into the speech or special voice effect by the digital to analog convertor 26 which is thus broadcasted via the speaker 27, thereby achievingt he purpose of reading out the content of a book or a card.

If the machine readable code 11 represents the digital waveforms of texts or symbols, what obtained by decoding from the decoder 23 of the sound generating device capable of reading codes 20 is a sound waveform, and thus can be directly converted by the digital to analog convertor 26 to produce the corresponding voices or special sound effects for being broadcasted via the speaker 27 without using the voice generating table 24.

Referring to FIG. 1 again, if the machine readable code 11 is printed on pages of a book 10 by ink, the sound generating device capable of reading codes 20 can capture the machine readable code 11 under a nomal light source 30. If the machine readable code 11 is printed on the pages of a book 10 by invisible light material, a special light source, such as an ultraviolet light source, is required to capture the machine readable code 11.

In view of the foregoing, it is known that the sound generating device capable of reading codes in accordance with the present invention is able to read the machine readable code on a printed material and generate corresponding voices without using any complex pattern recognization technology. With only a simple decoding operation, the recognization rate achieves a value of 100%. Moreover, special sound effect symbols, such as music score, can be read. As a result, the cost is lower while the performance is greatly increased.

Although the present invention has been explained in relation to its preferred embodiment, it is to be understood that many other possible modifications and variations can be made without departing from the spirit and scope of the invention as hereinafter claimed.

What is claim is:

1. A sound generating device capable of reading codes for reading machine readable code arranged on printing material to generate corresponding voice output, comprising:
an image sensor for capturing an image of the machine readable code;
an image processor for preprocessing the image of the machine readable code for acquiring identifiable image signals;
a decoder for decoding the image signals, based on encoding rules of the machine readable code, into texts or symboles represented by the machine readable code;
a voice generating table pre-stored with voice waveforms corresponding to various texts and symbols for converting the decoded texts or symbols into voice waveforms; and
a digital to analog convertor for converting the voice waveforms into corresponding analog speech or special sound effect to a speaker for broadcasting.

2. The sound generating device capable of reading codes as claimed in claim 1, further comprising a buffer for temporarily storing the texts or symbols obtained from the decoder and the voice waveforms obtained from the voice generating table.

3. The sound generating device capable of reading codes as claimed in claim 2, wherein the machine readable code is a two-dimensional barcode.

4. The sound generating device capable of reading codes as claimed in claim 2, wherein the image sensor is a CCD or CMOS semiconductor device.

5. A sound generating device capable of reading codes for reading machine readable code arranged on printing material, the machine readable code representing the digital waveforms of texts or symbols on the printing material, the device comprising:
an image sensor for capturing an image of the machine readable code;
an image processor for preprocessing the image of the machine readable code for acquiring identifiable image signals;
a decoder for decoding image signals, based on encoding rules of the machine readable code, into digitalized waveforms of texts or symboles represented by the machine readable code; and
a digital to analog convertor for converting the digitalized waveforms into corresponding analog speech or speech sound effect to a speaker for broadcasting.

6. The sound generating device capable of reading codes as claimed in claim 5, further comprising a buffer for temporily storing the digitalized waveforms of the texts or symbols obtained from the decoder.

7. The sound generating device capable of reading codes as claimed in claim 6, wherein the machine readable code is a two-dimensional barcode.

8. The sound generating device capable of reading code as claimed in claim 6, wherein the image sensor is a CCD or CMOS semiconductor device.
